(19) United States
(12) Patent Application Publication
(10) Pub. No.: US 2018/0191821 A1
(43) Pub. Date: Jul. 5, 2018

(54) Automatic User Group Clustering

(71) Applicant: Aiooki Limited, Grand Cayman, KY (US)

(72) Inventors: Lam Sun, Foster City, CA (US); Boxiong Ding, San Jose, CA (US); Kuan-Cheng Lai, Santa Clara, CA (US)

(21) Appl. No.: 15/687,533

(22) Filed: Aug. 27, 2017

Related U.S. Application Data
(60) Provisional application No. 62/441,968, filed on Jan. 4, 2017.

(51) Int. Cl. H04L 29/08; H04L 12/24

(52) U.S. Cl. CPC H04L 67/1044; H04L 41/0893

(57) ABSTRACT

A system for facilitating formation and management of a user group is disclosed. The system may be configured to facilitate forming of a user group for one or more purposes. A set of one or more user group rules may be associated with that user group. When the user group is requested to be formed, the set of group rule(s) may be examined against the request. The examination may include determining whether one or more conditions and/or policies specified in a given one of the group rule(s) are fulfilled. A notification may be generated to notify the initiator whether the one or more conditions are fulfilled to form the user group as requested and/or whether the requested user group can be formed.

### CROSS-REFERENCE TO RELATED APPLICATIONS

The present application claims priority to U.S. Provisional Patent Application No. 62/441,968, filed on Jan. 4, 2017 and entitled “FACILITATING GROUP FORMATION AND MANAGEMENT”, the disclosures of which is hereby incorporated by reference in their entireties for all purposes.

### BACKGROUND OF THE INVENTION

The disclosure relates to user group formation and management.

As the computer revolution advances, computer networking has become increasingly important. In recent years the number of computers which are connected to computer networks has increased rapidly. Not only are computers being connected to local networks, which might exist in a given building or group of buildings, but also wide area networks, which commonly connect local area networks in widely separated locations, such as the different facilities of a large corporation. In fact, within the last several years it has become increasingly common for computers to be hooked up to a global network formed of a large number of sub-networks called the Internet.

One exciting new application envisioned for the internet is interconnections between users from different parts of the world. Internet users want to share information with those who have a similar interest or affiliation or with an individually selected group, for example a group of friends or colleagues or a family group to achieve one or more common goals. It is desired to facilitate users to form user groups for such purposes. However, certain course of actions underlying the user groups may be subject to certain regulations and/or requirements depending on purposes of the user groups. For example, a user group that facilitates discussion of a certain technical topic of a current on-going research may require each user in the group to have certain credentials (e.g., number of scientific papers published for that topic, may impose a geographical distribution requirement (e.g., at least one user from certain geographical regions); and/or may exclude users from certain regions or countries from being included in the user group due to export control laws of the country where the research is taking place.

User group formation is a process to facilitate users to form a group for collaboration. Some prior art systems support manual user group formation only. These systems typically store user profile data and enable an administrator to manually form a user group based on the group members matching certain constraints as indicated by their profiles. However, these systems are limited in that they do not support automatic formation of a user group dynamically to ensure one or more regulations or rules are satisfied by the group. Thus, it may be desired to automatically and dynamically to facilitate formation of user groups.

### BRIEF SUMMARY OF THE INVENTION

A system for facilitating user group clustering or formation is provided. In one aspect, a rule-based user group clustering or formation mechanism is employed. Under this mechanism, a set of rules may be predefined for forming a user group of a particular group type. The set of rules may include one or more rules that govern membership criteria for the group and/or one or more rules that govern group formation criteria for the group. These rules may be automatically “enforced” against a set of candidate members when the group is requested to be formed. In some embodiments, when the user group is requested to be formed, these rules may be examined against each candidate member and as well as the group as a whole. The examination may include determining whether one or more conditions in accordance with these rules are fulfilled by the individual candidate members, and/or whether the user group may be formed in compliance with these rules based on the fulfillment of the one or more conditions. A notification may be generated to notify an initiator of the group whether the one or more rules are fulfilled to form the user group as requested.

In another aspect, one or more of the aforementioned group rules may specify a policy that should be conformed to by the group and/or individual candidate members before the group can be formed. In some embodiments, the policy may be obtained from a remote computing device from time to time and maintained by the system in accordance with the disclosure. The policy may be processed e.g., by using text parsing with predefined keywords or tokens. A set of values for one or more requirements may be obtained from the policy. When a user group is requested to be formed, each proposed candidate member in the user group may be “examined” against the requirement(s). A set of rules may be predefined and associated with the tokens such that those rules provide when the requested user group can be formed. For example, in the case of forming an investment group, the policies may include regulations and/or polices regarding investment by individuals in certain locality (e.g., UK). The tokens may include those indicating “UK citizenship”, “length of the investment”, “minimum funds for the group”, “minimum funds for each individual in the group” and any other such tokens. The rules can specify which one or ones of those tokens may be required for each member in the group based on their values so that the requested group can be formed.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 conceptually illustrates one example of a system for facilitating user group formation and management in accordance with the disclosure.

FIGS. 2A-B illustrates one example of an exemplary interface 200 that may facilitate an initiator to form a user group dynamically in accordance with the disclosure.

FIG. 3 illustrates various components that may be included in the system illustrated in FIG. 1.

FIG. 4 illustrates one example of interactions between the policy engine and rules component shown in FIG. 3 for forming a user group.

FIG. 5 illustrates an example of interactions among the rules component, the information component, and the compliance component shown in FIG. 3.

FIG. 6 illustrates an exemplary method for automatically forming a user group in accordance with the disclosure

FIG. 7 is a block diagram of computer system that can be used to implement various embodiments described and illustrated herein.

### DETAILED DESCRIPTION OF THE INVENTION

The present disclosure relates to facilitating user group formation and management. A system of configured to facilitate the user group formation and management may be provided. In various embodiments, the user group formation and management may be based on a set of one or more rules associated with the user group. The set of rules may be predefined for the user group. In certain embodiments, the set of rules may be predefined for a type of, a goal to be achieved by, and/or any other factors of the user group. During the life-cycle of the user group, the system may be configured to determine whether the user group is in compliance with the set of rules and determine one or more actions for curing one or more violations of the rules when the system determines the user group is not in compliance. With a general description of the system in accordance with the disclosure having been provided, attention is now directed to the following sections where an example of the system is described and illustrated.

### A System for Facilitating User Group Formation

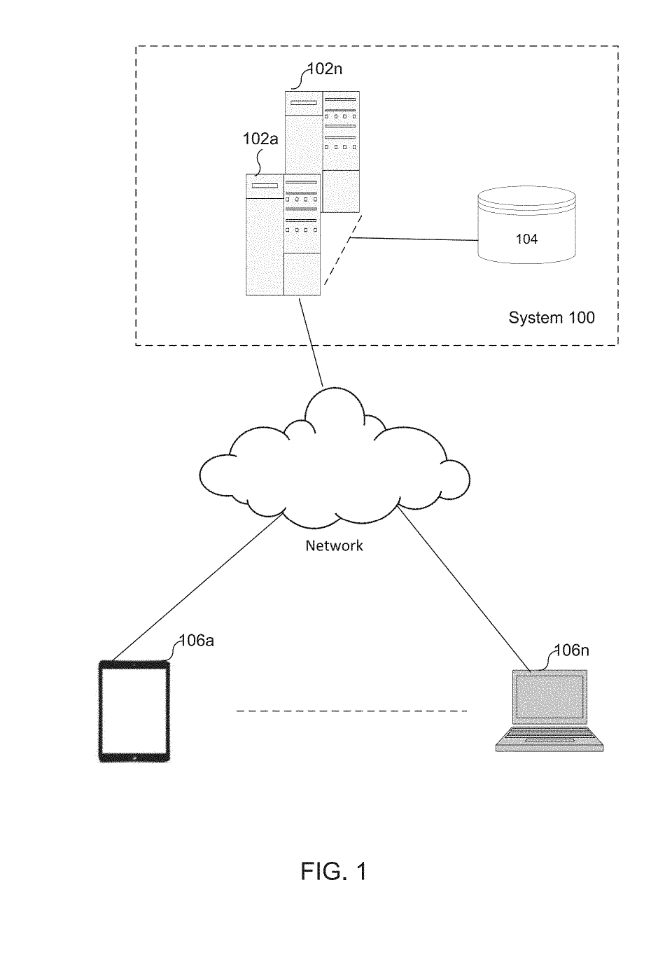

FIG. 1 illustrates an exemplary system 100 for facilitating user group formation or clustering in accordance with the disclosure. As shown, the system 100 may include servers 102a-n, a data store 104, and/or any other components. The servers 102a-n may include a web server configured to receive, via an internet, data requests from user applications such as browsers and apps on client computing devices 106a-n via a network such as the Internet. The web server can be configured to serve web pages to the user applications. In some embodiments, the web server can be configured to obtain user information, such as user answers to questionnaires posted on one or more pages served by the web server and/or user activity information automatically logged by the browsers and apps on the client computing devices 106a-n.

In certain embodiments, the web server may serve a page indicating various types of user groups that can be formed through system 100. The types of user group that can be formed by system 100 are not limited and may depend on an application of the system 100. In certain embodiments, the user groups that can be formed by system 100 may be categorized based on certain hierarchy, for example by geographical regions. For example, a first set of user groups of certain types may be formed for a first geographical region (e.g., China), a second set of user groups of certain types may be formed for a second geographical region (e.g., U.K.) and so on. The web server may list those types of user groups under the corresponding geographical regions. In some examples, the user groups can be categorized based on a function or a purpose they serve. For example, a set of user groups may be categorized as investment groups such that a given user group in that category can facilitate members in that user group to invest a certain type of asset(s). As illustration, the investment groups can include groups such as a peer to peer funding group for lending money to small entities, crowdsource funding groups for film projects, multi-investor group for investing a real-estate project, just to illustrate a few as examples.

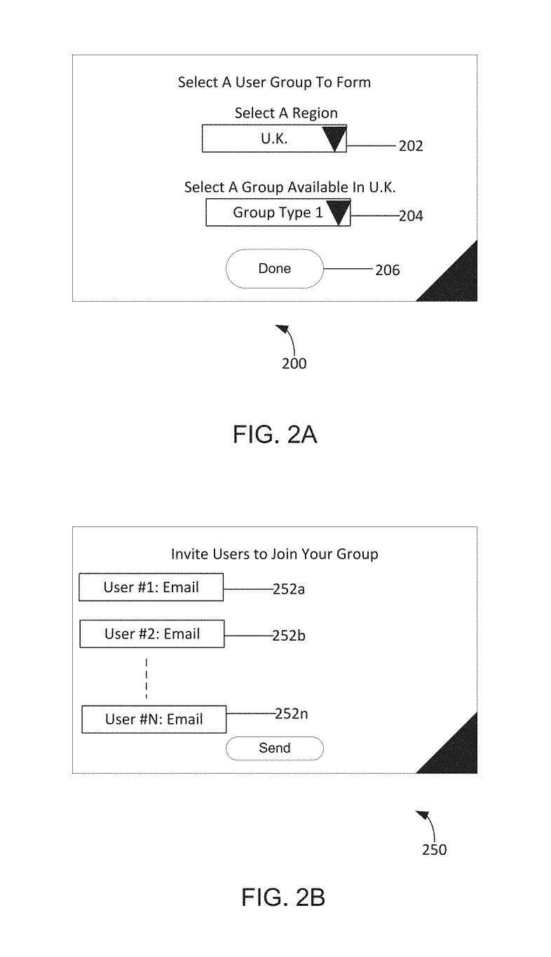

FIG. 2A illustrates one example of an exemplary interface 200 that may facilitate an initiator to form a user group dynamically in accordance with the disclosure. The interface 200 may be generated by the webs server described above. As shown in this example, the interface 200 may include a selection box 202 for the initiator to select a first criteria for the user group to be formed (e.g., a geographic region where the user group is to be formed), a second selection box 204 for the initiator to select a second criteria for the user group to be formed (e.g., a type of user group that can be formed in U.K. as shown—for instance a co-purchasing real-estate group, a learning group, a book club, a co-investment group or any other groups), and/or any other controls such as the button 206 for the initiator to generate a request to form the selected group.

The servers 102a-n may include a server that facilitates formation of the user groups. In implementations, such a server may be configured to receive a group formation request from a user computing device 106 via the web server described above. The group formation request may include information indicating a specific type of user group to be formed. In some embodiments, the group formation request can include information indicating a type of the to-be formed user group, one or more proposed group members to be included in the to-be formed user group, a time period for which the to-be user group is in effect—i.e., a period of life-cycle of the to-be formed user group, an identity of a person or persons that initiated the request to form the user group, and/or any other information.

In some embodiments, the server that facilitates user group formation may be configured to obtain information regarding 1) the initiator of the to-be formed user group; 2) the individual members included in the user group; and/or 3) details about certain items for the user group. This may involve generating one or more inquires to be complete by the initiator, one or more members included in the user group and/or any other parties. For example, the to-be formed user group may be a multi-investor group for a real-estate project, and the server may be configured to inquire the initiator to provide details about him/her, such as a valid identification number, his/her name, residence address, mailing address, social security number and/or any other information about the initiator; details of the real-estate project, such as the location, building information, bank information, and/or any other information regarding the real-estate project; member information regarding one or more members included in the multi-inventor user group. In some embodiments, the server may be configured to generate queries to obtain the member information regarding the members included in the to-be formed user group, for example their identities, their bibliographical information, their income information, their residence information, one or more declarations and/or statements from those members regarding one or more items in the group and/or any other information. In some implementations, the server may be configured to obtain such information periodically based on a predetermined schedule, for example every 7 days, 30 days, 90 days, or any other frequencies. In some implementations, the server may be configured to analyze the above-mentioned initiator, group items, and/or member information and determine whether one or more conditions for forming the user group have been fulfilled. For example, certain member funding requirements may be imposed for the multi-investor group mentioned above such that each member has to contribute a minimum amount of funds to a group bank account before the multi-investor group can be formed. In that example, the server may be configured to determine whether that conditions have been met before forming the user group.

The server that facilitates the formation of the user group can be configured to form the actual user group after it determines one or more conditions for forming the user group have been met. The formation of the user group by the server may include creating one or more group pages listing information regarding one or more group items, for example investment projects if the user group is for an investment purpose, research topics if the user group is for a research collaboration purpose, and/or any other group items. In some embodiments, the group pages created may include input controls (such as text input boxes) to enable individual group members to provide their inputs for collaborating with other group members. In some embodiments, the group pages created include action controls to enable individual group members to perform certain user actions, such as voting, generating an instructions for a third party service to act on behalf of the group, and/or any other group action. For example, if the user group is for an investment purpose, certain actions such as whether to fund a particular project may be provided in the group pages to solicit user votes. The server may be configured to generate a result of the voting and notify a third party service that can exercise funding action on behalf of the group (e.g., an escrow company or a financial service company) of the voting results so that the third party can act or not act on the funding action accordingly.

The servers 102a-n may include a policy server that can be configured to obtain one or more policies pertaining to a type of user group that can be formed by system 100. The policy server may be configured with information regarding various sources for obtaining such policies. Taking a crowdsource investment group in the US for example, the policy server may be configured to obtain policies governing formation of the crowdsource investment group from one or more servers of the SEC, a third party (e.g., a financial service company) and/or any other sources. That is, such a crowdsource investment group can be formed by system 100 and the policy server can be configured to obtain from difference sources policies regarding and/or governing the crowdsource investment group that can be formed by system 100. The policies obtained by the policy server may be stored in the data store 104. In some embodiments, the content of a given policy specified by group rule 404a need not be included in the group rule 404a. Instead, a source where such a policy may be obtained may be specified in the group rule 404a. For example, a URL where the crowdsource investment group policy issued by the state of California may be specified in the group rule 404a, and the policy server may be configured to download the content of this policy using the specified URL from time to time as desired.

In some embodiments, the policy server may be configured to analyze the policies obtained and retrieve one or more requirements for forming the user group governed by the policies. In those embodiments, one or more predetermined tokens may be defined by an analyst affiliated with system 100 and the values for the tokens may be populated by the policy server when the policies are analyzed. For example, still taking the co-investment group as an example, an SEC policy governing such a group may indicate certain citizenship restrictions, income restrictions for an investor that can make a crowdsource funding investment in the US. A set of tokens including “citizenship” and “income percentage” may be predetermined by the analyst in view of such SEC policies. The policy server may be configured to obtain the SEC policy periodically and analyze the SEC policies to determine or update the actual requirements of the SEC for those restrictions.

The servers 102a-n may include a management server configured to manage user groups already formed by system 100. Managing a given user group by the management server can include monitoring members in the given user group and obtaining relevant member information for determining whether fulfillment of one or more conditions of the user group is maintained in accordance with the policies pertaining to the user group. For example, in the investment group above, there may be certain investment amount restriction imposed by the SEC such that individual group member may not invest more than a certain percentage (e.g., 5%) of his/her annual income or net worth (whichever is greater). In that example, the management server can be configured to periodically inquire each member in the group about his/her annual income or net worth, for example once every half year or a year. With the answer from the user member, the management server can be configured to determine whether the actual investment made by the member has exceeded the maximum percentage of annual income or net worth as reported by the user member. If the management server determines that such a percentage has been breached, the management server may be configured to generate a notification to that member and/or the initiator of investment to inform them of such a violation of the group policies. In some embodiments, the management server may be configured to set a time period for the member to cure his/her violation before suspending his/her membership in the group in accordance with the group policies. In the case where the violating member does not cure the violation after the time period, the management system may effectuation a suspension of the membership of that user until the issue is resolved.

In some embodiments, the management server may be configured to obtain information regarding group items and determine whether the group items satisfy one or more conditions in accordance with the group policies. For example, for a research group, the group items may include one or more scientific papers published by a research institute for discussion by members in the group. In that example, the group rules may specify eligible papers for the discussion within the group must be from a range of certain topics and must be authorized by the research institute for discussion on the Internet. In that example, when a paper is posted on the group page, the management server may be configured to examine the paper using these criteria to determine whether the paper is in compliance with the group policy.

As another example, the user group may be a peer to peer investment group, and from time to time, the initiator of the group may post information regarding an entity for the group to consider funding. In that example, the group policies may specify eligible entity for such funding must satisfy certain requirements such a minimum credit score, minimum amount of assets in possession and/or any other requirements. In that example, when the information regarding the entity is requested to be posted on the group pages, the management server may be configured to examine whether the entity satisfy those requirements. In the case where the management server determines those requirements are not met, the management server can be configured to notify the initiator and/or group members of such, and/or may not let the information regarding the entity posted on the group pages.

In some embodiments, the management server may be configured to suspend a member's membership if the member does not cure his/her violation of a group rule within a certain time period. In some embodiments, the management server may be configured to suspend the user group if a group item and/or a member is not in compliance with the group rules for a certain period of time.

In some embodiments, the management server may be configured to facilitate one or more group actions to be performed. Examples of the group actions that can be facilitated by the management server may include instructing a third party to provide a service to the group, to elect one or more positions within the group, to vote for certain group rules, to cast opinions and/or feedbacks regarding certain items, and/or any other group actions. For example, as mentioned above, in the case where the group is an investment group, the management server may be configured to facilitate the group to fund an investment project when majority of the group approve funding of the investment project. In that example, the management server may be configured to enable each group member to vote for such a funding decision by providing a vote button on the group pages, tally the votes, and generate an instruction to a third party service (e.g., an escrow that controls an account for the group) to fund the project when a majority of the members voted to fund the project. In some embodiments, the management server may be configured to check whether all of the members have voted and generate notifications to those members that have not voted to remind them that they need to vote by a certain deadline.

It should be understood the various servers described above are merely illustrative. The functions attributed to different one of these servers may, in some other embodiments, be performed by a same server. In some other embodiment, more servers may be employed to provide implement functions than the ones described above. One skilled in the art will understand a system in accordance with the disclosure for facilitating group formation and management is not limited to including only the servers described above. There could be more or less servers than the example described above in some other examples.

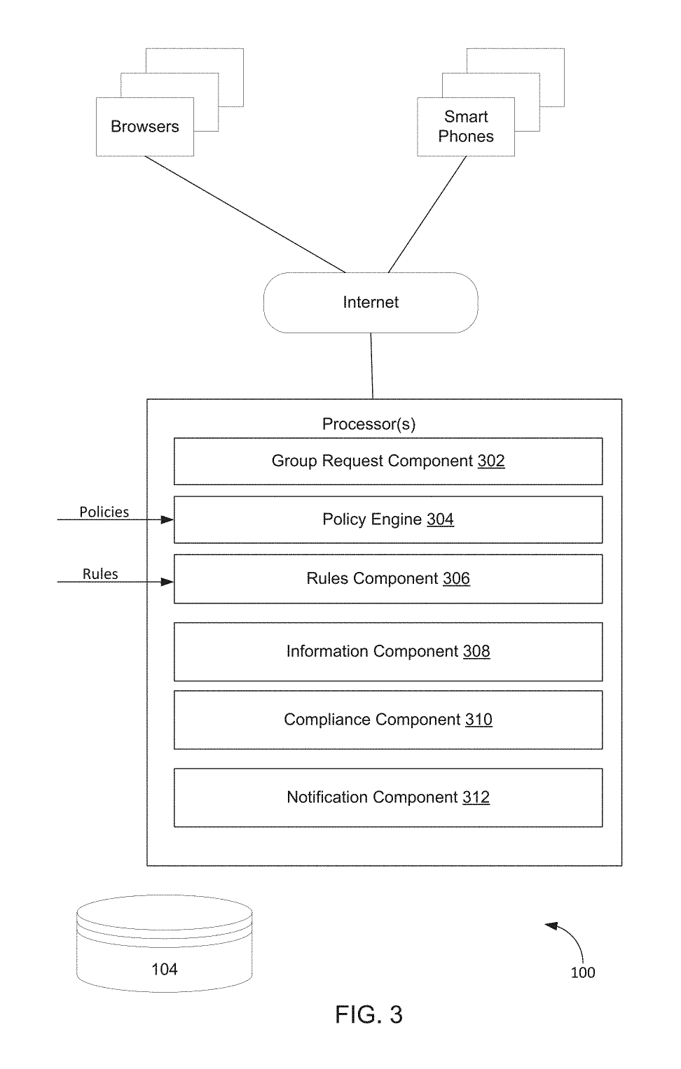

With exemplary system 100 for facilitating group formation and management in accordance with the disclosure having been generally described, attention is now directed to FIG. 3, where examples of various components that may be included in the system illustrated in FIG. 1 are illustrated. As shown, the system 100 shown in FIG. 1 may include one or more processors configured to execute program components, which may include a group request component 303, a policy engine 304, a rules component 306, an information component 308, a compliance component 310, a notification component 312, and/or any other components.

The group request component 302 may be configured to receive a request from a browser or an app on a client computing device such as the client computing device 106 shown in FIG. 1. The request received by the group request component 302 may include a request to form a user group, a request to add or delete one or more group items, a request to initiate a group action, a request to add a member to the user group and/or any other types of request related to a user group. The request to form a user group may include information indicating a type of the user group to be formed, an identity of the requestor or the initiator, identities of one or more group members to be included in the to-be formed user group, one or more group items to added to the to-be formed group, and/or any other information. The identities of the one or more group members to be included in the in the to-be formed user group may include their contact information (such as an email address and/or mailing address), their identification numbers (e.g., their driver license numbers, social security numbers, their national identification card numbers), their residence information, their citizenship information, and/or any other information.

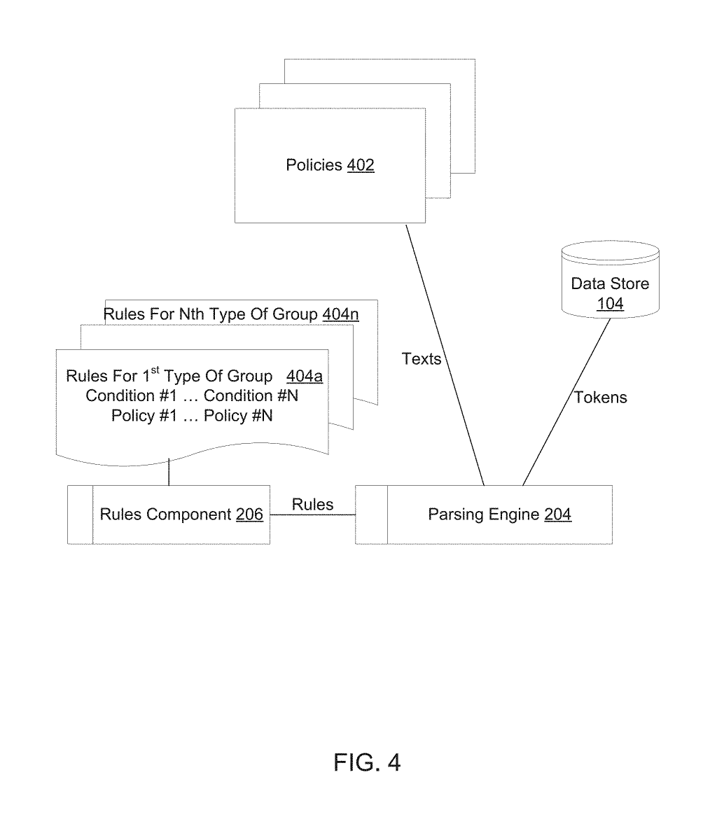

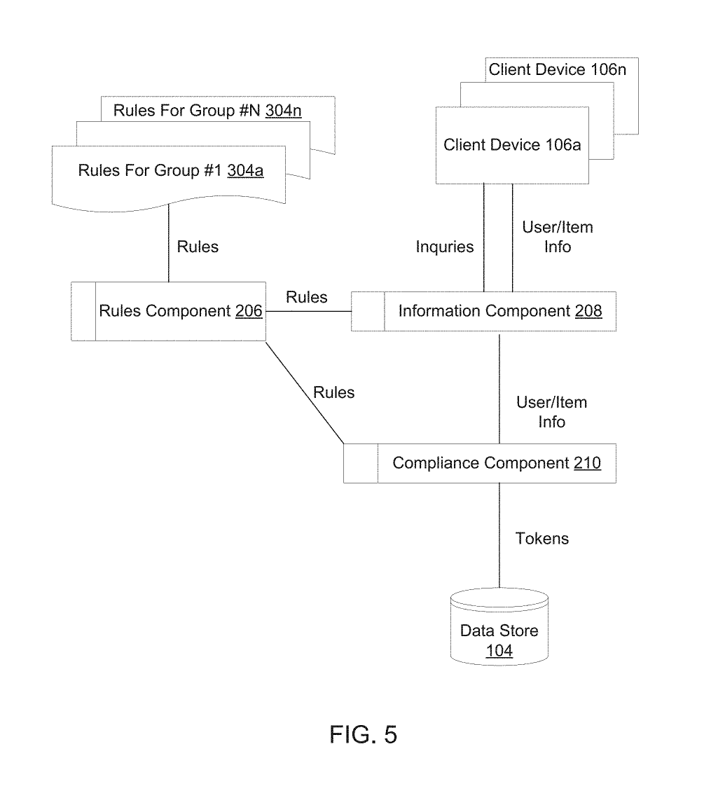

The policy engine 304 may be configured to obtain polices from various sources, analyze the policies in accordance with one or more rules for the group. The rules component 306 may be configured to obtain retrieve rules for user groups and provide the rules to various other components for further processing, such as policy engine 304, the user information component 308, the compliance component 310 and/or any other components. The information component 308 may be configured to obtain user information regarding one or more members of the group and/or the initiator of the group. The information component 308 may be configured to obtain information regarding one or more group items. The compliance component 310 may be configured to determine whether one or more conditions or requirements as specified by the group rules retrieved by the rules component 306 are met. The notification component 312 may be configured to generate a notification to notify the initiator and/or a group member regarding the formation of the user group as requested by the initiator. With the functions of these components having been generally described, details of interactions between these components for different applications of system 100 will be provided below in reference with FIGS. 4-5.

### Forming a User Group

FIG. 4 illustrates one example of interactions between the policy engine 304 and rules component 306 for forming a user group. As mentioned above, each type of user group that can be formed by system 100 can be associated with one or more rules, such as rules 404a-n. The one or more rules associated with a particular user group type may be referred to as group rules for that group type. On the other hand, a given group rule, such as rule 404a may be asociated with more than one group type. As shown, the given rule, such as rule 404a may specify one or more conditions that should be satisfied by one or more members in the group and/or the group as a whole before the group can be formed. For example, as shown, the conditions specified in the group rule 404a may include a condition indiciating each member in the group must be over 18 years old; a condition indicating there are at least 5 members in the group must hold a position of prefessorship in a higher institution (e.g., the group is for learning); a condition indicating that the group cannot have more 30 members; and/or any other conditions. As can be seen, these conditions may relate to each member in the group, some members in the group, or the group as a whole. Other examples of conditions that can be specified in the group rule are contemplated.

The given group rule such as group rule 404a may also specify one or more policies pertaining to individual group members and/or the group as a whole. Different from the conditions mentioned above, which may be predefined by an administrator, a provider of the system 100 and/or the initiator of the group, the polices specified in the given group rule may be defined by a government body, by an institute, an agency and/or any other type of entity that may regulate the type of user group the given group rule is associated with. An example of a policy may include a policy regarding co-investment in a real-estate project in California for a co-investment group that can be formed by system 100. The policy may be

In some embodiments, the group rules may be predetermined by a provider or an operator of system 100, an administrator of system 100, a third party associated with system 100, and/or any other entities associated with system 100. In some implementations, the group rules may be stored in memory storage of system 100, or in data store 104. As an example, a set of group rules may be predetermined for a P2P investment group in the California U.S. For example, the predetermined rules may specify that the P2P investment must conform to the latest regulations issued by SEC regarding certain financing actions for P2P investment, California state regulations regarding lending, and/or any other requirements. In some embodiments, the group rules for a given group may be provided by the initiator of the group. For example, additional group rules may be provided by the initiator when an instance of the P2P investment group is requested to be formed by the initiator. For example, such rules may include maximum number of members that may be included in the group, and a life-cycle of the group (e.g., the group will exist for 6 month).

The rules component 306 may be configured to retrieve one or more rules for forming a specific type of group after a request for forming such is received by the group request component 302. For example, in response to a specific type of group requested to be formed, the rules component 306 may retrieve the group rule(s) associated with that type of group. The policy engine 304 may be configured to obtain (e.g., download) policies 302 from various sources in accordance with the group rules. For example, the provider of system 100 may specify in the group rules for a multi-investor user group that such a group must conform to the latest SEC regulations regarding crowdsource funding. In that example, the policy engine 304 may be configured to retrieve such policies from one or more servers of the SEC after the request for forming such a group is received. In implementations, a communication interface may be established with such servers of the SEC. In another example, the policies may be provided by a third party service provider (such as a financial service company), and a communication interface may be established with one or more servers of the third party service provider. Still as another example, in some embodiments, the policy engine 304 may be configured to download such policies periodically and store them in the data storage 104, and to retrive a specific policy from storage 104 when a request to form a goup that has to conform to the policy as specified by the associated group rule is received.

In any case, a given policy 402 retrieved by the policy engine 304 may include texts. In implementations, the policy engine 304 may be configured to parse the policy texts to populate one or more tokens corresponding to the polices 402. The tokens may be predetermined, for example by the provider of system 100 and specified in the group rules 304. For example, a set of tokens such as “citizenship requirement”, “maximum percentage of income for investment”, “maximum investment period” and/or any other tokens may be specified by the provider of system 100 for a P2P investment group that can be formed in California U.S. In that example, such tokens may be included in one of the group rules as texts and policy engine 304 may be configured to read the rule, parse the policies 402 for these tokens, and populate the tokens based on the parsing results. For example, the policy engine 304 may parse the SEC policy of P2P funding for any information regarding citizenship requirement and populate the “citizenship requirement” token with the actual value specified in the policy—for example, “U.S. citizen only”. As another example, the policy engine 304 may parse the SEC policy of P2P funding for any information regarding “maximum percentage of income for investment” and populate it with “5%” (to indicate 5% of income). As illustrated in FIG. 3, such populated tokens can then be stored in the data store 104 in association with the specific type of group (e.g., crowdsource funding group).

Attention is now directed to FIG. 5, wherein an example of interactions among the rules component 306, the information component 308, and the compliance component 310 is illustrated. As shown, in response to the group formation request having been received by the group request component 302, the rules component 306 may be configured to retrieve the group rules associated with the user group requested to be formed, for example rules 404a. These rules may instruct the information component 408 to obtain certain information regarding the initiator, members to be included in the user group, and/or items to be included in the user group. For achieving these, the information component 308 may be configured to generate one or more inquires for completion by the initiator, one or more members included in the user group and/or any other parties. These inquiries may be transmitted to client computing devices 106a-n associated with these entities for their completion. For example, in the case where the to-be formed user group is a multi-investor group for a real-estate project, and the information component 308, in accordance with the group rules associated with such a group as retrieved by the rules component 306, may be configured to inquire the initiator to provide details about him/her, such as a valid identification number, his/her name, residence address, mailing address, social security number and/or any other information about the initiator; details of the real-estate project, such as the location, building information, bank information, and/or any other information regarding the real-estate project; member information regarding one or more members included in the multi-inventor user group.

In some embodiments, the information component 308 may be configured to generate queries to obtain the member information regarding the members included in the to-be formed user group, for example their identities, their bibliographical information, their income information, their residence information, one or more declarations and/or statements from those members regarding one or more items in the group and/or any other information. In some embodiments, the information component 308 may be configured to generate queries to obtain information regarding one or more group items to be included in the to-be formed group. These queries can be transmitted to the client computing devices 106 associated with the initiator and/or one or more third party service providers. For example, in the case where the group is a multi-investor group, the initiator may request to include a real-estate project in the to-be formed group. In that example, the information component 308 may inquire the initiator to provide more information regarding the real-estate project in accordance with the group rules, for example such as location and bank information regarding the real-estate project. Still in that example, the information component 208 may be configured obtain further information from a bank where the real-estate project is currently financed in response to receiving the bank information from the initiator.

In some implementations, the information component 308 may be configured to obtain such information periodically based on a predetermined schedule, for example every 7 days, 30 days, 90 days, or any other frequencies. For example, if the compliance component 310 determines one or more conditions specified in the group rule(s) are not met for forming the requested group, the information component 308 may be configured to so periodically obtain such information until the conditions are met or until a predetermined period has expired. As illustration, in the case where some members to be included in the requested user group do not respond to the inquires regarding their identities and other necessary information for forming the requested group, the information component 208 may continue to send these inquires, e.g., via email, to those members until either they respond or until a predetermined period (e.g., 10 days after the group was requested to be formed) has expired.

The compliance component 310 may be configured to analyze the above-mentioned initiator, group items, and/or member information obtained by the information component 208 and determine whether one or more conditions for forming the user group have been fulfilled in accordance with the group rules. For example, certain member funding requirements may be imposed for the multi-investor group mentioned above such that each member has to contribute a minimum amount of funds to a group bank account before the multi-investor group can be formed. In that example, the compliance component 310 may be configured to determine whether that condition has been met before the user group can be formed. In implementations, for such a determination, the compliance component 310 may be configured to read the group rules and retrieve populated tokens from the data store 104 in accordance with the group rules, compare the information obtained by the information component 308 with the tokens, and determine whether the group items and/or the members to be included in the to-be formed user group have satisfied the values of those tokens. For example, if the tokens include a token of “citizenship requirement” that specifies “US only”, the compliance component 310 can compare citizenship information regarding each member as obtained by the information component 308 against that token to determine whether those members are all U.S. citizen and thus satisfy the “citizenship requirement”.

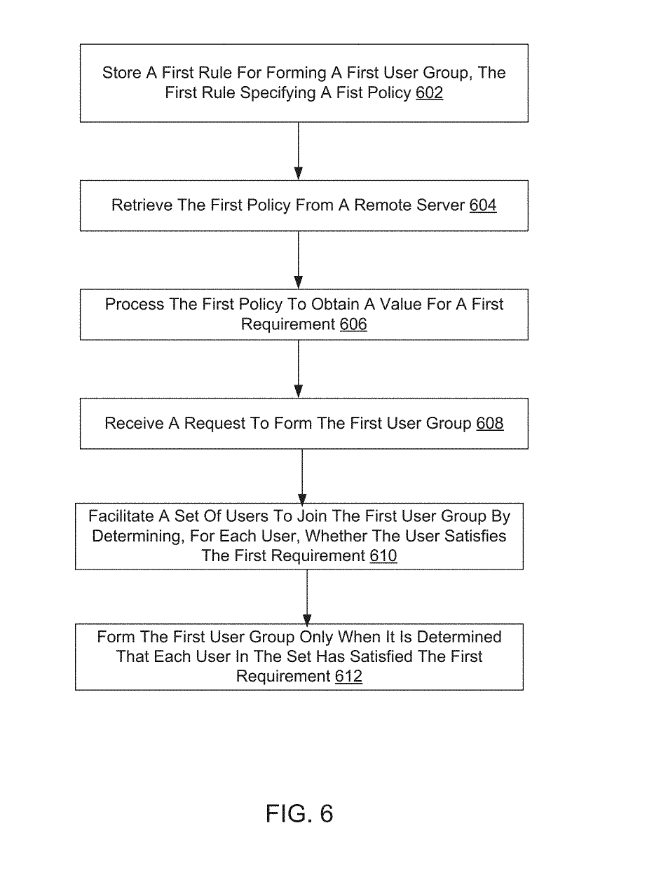

FIG. 6 illustrates an exemplary method 600 for automatically forming a user group in accordance with the disclosure. The method presented in FIG. 6 and described below is intended to be illustrative and non-limiting. The particular series of processing steps depicted in FIG. 6 is not intended to be limiting. It is appreciated that the processing steps may be performed in an order different from that depicted in FIG. 6 and that not all the steps depicted in FIG. 6 need be performed.

In some embodiments, the method depicted in method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At 602, rules for forming individual user group can be stored in storage, such as the data storage 104. The rules stored at 602 may include a first rule specifying a policy for forming a first user group. The first policy may include a policy predetermined by a government body, an agency, and/or an entity related to rule making or regulations for forming groups. An example of the first rule may include California state regulations regarding lending. In some exemplary implementations, operations involved in 602 can be implemented by a rules component the same as or substantial similar to the rules component 306 described and illustrated herein.

At 604, the first policy forming the first user group can be retrieved. For example, the policy for California state regulations regarding lending can be downloaded from a remote server provided b the State of Californa, a third party provide and/or any other entities. In some exemplary implementations, operations involved in 604 can be implemented by a policy engine the same as or substantial similar to the policy engine 304 described and illustrated herein.

At 606, the first policy retrieved at 604 can be processed to value of a first requirement. Processing of the first policy at 604 can involve parsing the policy texts to populate one or more tokens corresponding to the first policy. Examples of the tokens corresponding to the first policy can include “citizenship requirement”, “maximum percentage of income for investment”, “maximum investment period” and/or any other requirements. In some exemplary implementations, operations involved in 606 can be implemented by a policy engine the same as or substantial similar to the policy engine 304 described and illustrated herein.

At 608, a request to form the first user group can be received. The request to form the first user group may include information indicating the type of the first user group to be formed, an identity of the requestor or the initiator, identities of one or more group members to be included in the first user group, one or more group items to added to the first user group, and/or any other information. In some exemplary implementations, operations involved in 608 can be implemented by a group request component the same as or substantial similar to the group request component 302 described and illustrated herein.

At 610, a set of users can be facilitated to join the first user group. Facilitating the users to join the first user group at 610 can include obtaining information regarding the users. Operations at 610 can also include determining, for each of the users, whether the user conforms to the first requirement in the first policy. In some exemplary implementations, operations involved in 610 can be implemented by a information component the same as or substantial similar to information component 308 described and illustrated herein.

At 612, the first user group can be formed only when it determined that every user in the set has satisfied the first requirement. In some exemplary implementations, operations involved in 612 can be implemented by a compliance component the same as or substantial similar to compliance component 310 described and illustrated herein.

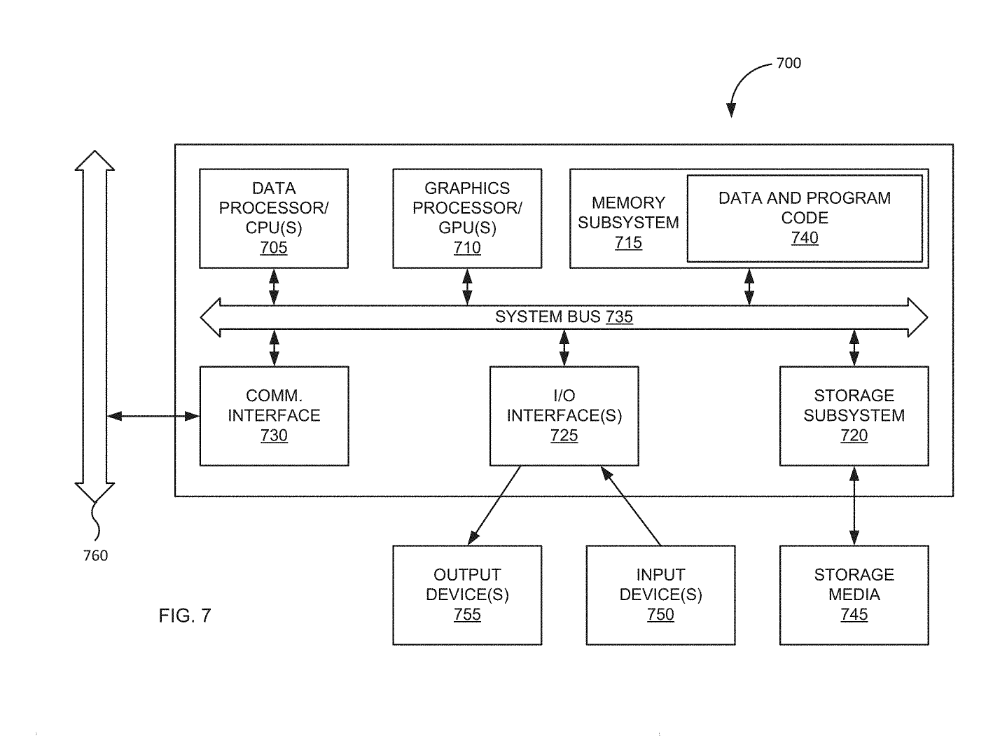

FIG. 7 is a block diagram of computer system 700 that can be used to implement various embodiments described and illustrated herein. FIG. 7 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 700 and any of its components or subsystems can include hardware and/or software elements configured for performing methods described herein.

Computer system 700 may include familiar computer components, such as one or more one or more data processors or central processing units (CPUs) 705, one or more graphics processors or graphical processing units (GPUs) 710, memory subsystem 715, storage subsystem 720, one or more input/output (I/O) interfaces 725, communications interface 730, or the like. Computer system 700 can include system bus 735 interconnecting the above components and providing functionality, such connectivity and inter-device communication.

The one or more data processors or central processing units (CPUs) 705 can execute logic or program code or for providing application-specific functionality. Some examples of CPU(s) 705 can include one or more microprocessors (e.g., single core and multi-core) or micro-controllers, one or more field-gate programmable arrays (FPGAs), and application-specific integrated circuits (ASICs). As used herein, a processor includes a multi-core processor on a same integrated chip, or multiple processing units on a single circuit board or networked.

The one or more graphics processor or graphical processing units (GPUs) 710 can execute logic or program code associated with graphics or for providing graphics-specific functionality. GPUs 710 may include any conventional graphics processing unit, such as those provided by conventional video cards. In various embodiments, GPUs 710 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 710 may include any number of registers, logic units, arithmetic units, caches, memory interfaces, or the like.

Memory subsystem 715 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 715 can include data and program code 740.

Storage subsystem 720 can also store information using machine-readable articles, information storage devices, or computer-readable storage media. Storage subsystem 720 may store information using storage media 745. Some examples of storage media 745 used by storage subsystem 720 can include floppy disks, hard disks, optical storage media such as CD-ROMS, DVDs and bar codes, removable storage devices, networked storage devices, or the like. In some embodiments, all or part of data and program code 740 may be stored using storage subsystem 720.

The one or more input/output (I/O) interfaces 725 can perform I/O operations. One or more input devices 770 and/or one or more output devices 777 may be communicatively coupled to the one or more I/O interfaces 725. The one or more input devices 770 can receive information from one or more sources for computer system 700. Some examples of the one or more input devices 770 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 770 may allow a user of computer system 700 to interact with one or more non-graphical or graphical user interfaces to enter a comment, select objects, icons, text, user interface widgets, or other user interface elements that appear on a monitor/display device via a command, a click of a button, or the like.

The one or more output devices 777 can output information to one or more destinations for computer system 700. Some examples of the one or more output devices 777 can include a printer, a fax, a feedback device for a mouse or joystick, external storage systems, a monitor or other display device, a communications interface appropriately configured as a transceiver, or the like. The one or more output devices 777 may allow a user of computer system 700 to view objects, icons, text, user interface widgets, or other user interface elements. A display device or monitor may be used with computer system 700 and can include hardware and/or software elements configured for displaying information.

Communications interface 730 can perform communications operations, including sending and receiving data. Some examples of communications interface 730 may include a network communications interface (e.g. Ethernet, Wi-Fi, etc.). For example, communications interface 730 may be coupled to communications network/external bus 760, such as a computer network, a USB hub, or the like. A computer system can include a plurality of the same components or subsystems, e.g., connected together by communications interface 730 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

Computer system 700 may also include one or more applications (e.g., software components or functions) to be executed by a processor to execute, perform, or otherwise implement techniques disclosed herein. These applications may be embodied as data and program code 740. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 715 and/or storage subsystem 720.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed:

1. A method for automatically forming a user group, the method being implemented by a processor configured to execute computer programs, the method comprising:
storing, in a storage operatively connected to the processor, a first set of rules associated with a first group type, each of the first set of rules specifying at least one condition and one policy for forming a first user group of the first group type, wherein the first set of rules includes a first rule specifying a first policy the first user group should conform to;
retrieving the first policy from a remote computing device according to the first rule;
processing the first policy using a first set of predetermined tokens associated with the first policy such that a value for a first requirement is obtained from the first policy;
receiving a request to form the first user group; and
facilitating a set of users to join the first user group, wherein the facilitating includes:
for each user in the set,
obtaining user information from the user; and
determining whether the user satisfies the first requirement based on the user information; and
forming the first user group with the set of users only when it is determined that each user in the set has satisfied the first requirement.

2. The method of claim 1, wherein the first policy specifies a location where the first policy can be downloaded.

3. The method of claim 1, further comprising receiving the first rule from a user.

4. The method of claim 1, wherein the first rule further includes a first condition such that the first condition must be satisfied before the first user group can be formed.

5. The method of claim 1, wherein the first rule further specifies the first policy must be conformed to when forming a user group of a second user type

6. The method of claim 1, wherein the first set of rules includes a second rule specifying a second policy the first user group should conform to;
retrieving the second policy from a remote computing device according to the second rule;
processing the second policy using a second set of predetermined tokens associated with the second policy such that a value for a second requirement is obtained from the second policy;
for each user in the set,
determining whether the user satisfies the second requirement based on the user information; and
forming the first user group with the set of users only when it is determined that each user in the set has satisfied the first requirement and the second requirement.

7. The method of claim 1, further comprising:
receiving a request to form a second user group, the second user group being of the first group type; and
facilitating the set of users to join the second user group, wherein the facilitating includes:
for each user in the set,
obtaining user information from the user; and
determining whether the user satisfies the first requirement based on the user information; and
forming the second user group with the set of users only when it is determined that each user in the set has satisfied the first requirement.

8. The method of claim 1, wherein obtaining user information from the user comprises:
generating a user information request and transmitting the user information request to a computing device associated with the user.

9. The method of claim 1, wherein the group types include a second user group type, and the first set of rules includes a second rule specifying a second policy a second user group of the second user group type should conform to;
retrieving the second policy from a remote computing device according to the second rule;
processing the second policy using a second set of predetermined tokens associated with the second policy such that a value for a second requirement is obtained from the second policy;
receiving a request to form the second user group; and
facilitating a set of users to join the second user group, wherein the facilitating includes:
for each user in the set,
obtaining user information from the user; and
determining whether the user satisfies the second requirement based on the user information; and
forming the second user group with the set of users only when it is determined that each user in the set has satisfied the second requirement.

10. A system for automatically forming a user group, the system comprising a processor configured to execute machine-readable instructions such that when the machine readable instructions are executed, the system is caused to perform:
storing, in a storage operatively connected to the processor, a first set of rules associated with a first group type, each of the first set of rules specifying at least one condition and one policy for forming a first user group of the first group type, wherein the first set of rules includes a first rule specifying a first policy the first user group should conform to;
retrieving the first policy from a remote computing device according to the first rule;
processing the first policy using a first set of predetermined tokens associated with the first policy such that a value for a first requirement is obtained from the first policy;
receiving a request to form the first user group; and
facilitating a set of users to join the first user group, wherein the facilitating includes:
for each user in the set,
obtaining user information from the user; and
determining whether the user satisfies the first requirement based on the user information; and
forming the first user group with the set of users only when it is determined that each user in the set has satisfied the first requirement.

11. The system of claim 10, wherein the first policy specifies a location where the first policy can be downloaded.

12. The system of claim 10, wherein the processor is further caused to perform: receiving the first rule from a user.

13. The system of claim 10, wherein the first rule further includes a first condition such that the first condition must be satisfied before the first user group can be formed.

14. The system of claim 10, wherein the first rule further specifies the first policy must be conformed to when forming a user group of a second user type

15. The system of claim 10, wherein the first set of rules includes a second rule specifying a second policy the first user group should conform to;
retrieving the second policy from a remote computing device according to the second rule;
processing the second policy using a second set of predetermined tokens associated with the second policy such that a value for a second requirement is obtained from the second policy;
for each user in the set,
determining whether the user satisfies the second requirement based on the user information; and
forming the first user group with the set of users only when it is determined that each user in the set has satisfied the first requirement and the second requirement.

16. The system of claim 10, wherein the processor is further caused to perform:
receiving a request to form a second user group, the second user group being of the first group type; and
facilitating the set of users to join the second user group, wherein the facilitating includes:
for each user in the set,
obtaining user information from the user; and
determining whether the user satisfies the first requirement based on the user information; and
forming the second user group with the set of users only when it is determined that each user in the set has satisfied the first requirement.

17. The system of claim 10, wherein obtaining user information from the user comprises:
generating a user information request and transmitting the user information request to a computing device associated with the user.

18. The system of claim 10, wherein the group types include a second user group type, and the first set of rules includes a second rule specifying a second policy a second user group of the second user group type should conform to;
retrieving the second policy from a remote computing device according to the second rule;
processing the second policy using a second set of predetermined tokens associated with the second policy such that a value for a second requirement is obtained from the second policy;
receiving a request to form the second user group; and
facilitating a set of users to join the second user group, wherein the facilitating includes:
for each user in the set,
obtaining user information from the user; and
determining whether the user satisfies the second requirement based on the user information; and
forming the second user group with the set of users only when it is determined that each user in the set has satisfied the second requirement.
